(19) United States
(12) Patent Application Publication
(10) Pub. No.: US 2026/0107165 A1
(43) Pub. Date: Apr. 16, 2026

(54) SELF CALIBRATING TESTBED

(71) Applicant: Spirent Communications, Inc., Santa Clara, CA (US)

(72) Inventors: Janne Linkola, Lexington, MA (US); Edwin Shearer, Pleasanton, CA (US)

(73) Assignee: Spirent Communications, Inc., Santa Clara, CA (US)

(21) Appl. No.: 18/913,993

(22) Filed: Oct. 11, 2024

(51) Int. Cl. H04W 24/06; H04W 84/12

(52) U.S. Cl. CPC H04W 24/06; H04W 84/12

(57) ABSTRACT

The technology disclosed concerns a method, system, and computer media for self-calibrating a test environment to replicate path loss between wireless devices in a model environment despite Over the Air coupling uncertainty. The test environment has a controller and test chambers holding wireless devices and connected by connective cables fitted with attenuators and measurement devices. For a pair of test chambers, the controller causes generation of first and second reference signals to be transmitted over a respective cable, to and from the held wireless devices. The controller receives, from the respective measurement device on the respective connective cable, measurements of the first and second reference signals. The controller sends configuration signals to the respective attenuator based on the measurements of the first and second reference signals, causing the respective attenuator to reproduce path loss in the model environment between the pair of signal sources.

### RELATED APPLICATION(S)

This application is related to the following commonly owned applications:

U.S. patent application Ser. No. 18/817,156 titled “Method and System for End-to-End Calibration of a Channel Emulator,” filed on 27 Aug. 2024 (Attorney Docket 1178-1), which is incorporated by reference; and

U.S. Provisional Patent Application No. 63/702,046 titled “Evaluating Quality of Experience in Mesh Networks,” filed 1 Oct. 2024 (Attorney Docket 1176-1), which is incorporated by reference.

### FIELD OF INVENTION

The technology disclosed relates to calibrating a testbed. In particular, the technology relates to measuring and accounting for Over the Air (“OTA”) path loss when emulating a network of devices. The effects of physical distance and material effects on attenuation are reproduced in the testbed. The technology enables testbeds to self-calibrate, even when the testbed is configured for OTA testing.

### ACRYONYMS

Acronyms used in this disclosure are identified the first time that they are used. These acronyms are terms of art, often used in standards documents. Except where the terms are used in a clear and distinctly different sense than they are used in the art, we adopt the meanings found in testing standards. For the reader's convenience, many of them are listed here:

| | |
|---|---|
| AP | Access Point |
| MCS0 | Modulation Coding Scheme 0 |
| OTA | Over the Air |
| QoE | Quality of Experience |
| RF | Radio Frequency |
| RSSI | Received Signal Strength Indicator |
| RSRP | Reference Signal Received Power |
| STA | Station |
| TR | Technical Report |

### BACKGROUND

It is desirable for wireless testbeds to accurately simulate path loss in networks of wireless devices. These wireless testbeds measure various metrics related to the networks or the devices.

Two options to couple the antenna of a wireless device to send signals to other wireless devices during testing are OTA coupling and galvanic connection.

Configuring a testbed requires that the tester account for the path loss when emulating communication between wireless devices.

A testing-industry recognized concern is that OTA testing adds variance to the insertion loss (aka path loss) between electromagnetically-isolated test chambers. An early wireless device performance testing standard, TR-398, was introduced by the Broadband Forum in 2019. The latest version of TR-398 in 2024 still expressly cautions about testing with two wireless OTA connections along a path, in the multiple chamber testing environment implementations section of the standard. See Broadband Forum, Wi-Fi Residential & SOHO Performance Testing Section, March 2024, TR-398 Issue 3, page 22 (available at hxxps://www.broadband-forum.org/pdfs/tr-398-3-0-0.pdf). This is because the variance introduced by multiple OTA testing hops is likely to exceed the permitted test variance.

### BRIEF DESCRIPTION OF THE DRAWINGS

FIG. 1 illustrates a block diagram of a wireless device testbed that emulates a wireless network.

FIG. 2 illustrates a connective cable between a pair of test chambers, including an Over the Air gap, being configured by a controller.

FIG. 3 is a message diagram illustrating messages exchanged during self-calibration of a pairwise connection over a connective cable between a pair of signal sources in the testbed.

FIG. 4 is a block diagram illustrating functional blocks of the controller that are involved in self-calibration.

FIG. 5 is a block diagram of an example computer system.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

Historically, testing of wireless devices has relied on galvanic (soldered) connection of an RF conductive cable to antennas on the wireless devices. The galvanic connection is a stable connection with minimal insertion loss (aka path loss.) Wireless devices with multiple antennas and beamforming cannot be fairly tested using galvanic connections. With increasingly complex antenna configurations, testing has progressed to Over the Air (“OTA”) testing.

In a test chamber, which is part of a testbed, the OTA path loss is a source of great uncertainty that can only be resolved empirically, by measurement. This is because OTA path loss depends on beam forming, precise orientation of antennas both in the wireless device and on walls of the test chamber, and the short distance between the wireless device and the antennas on the walls.

Testing requirements have evolved as the number wireless devices in common homes has increased. A complex testbed can include multiple chambers holding wireless devices and multiple emulation stations that feed signals to the chambers. A testbed needs to be complex to come close to emulating a common home that contains, for instance, three wireless access points, a mesh access extender, five cellular phones, four wireless tablets, three laptops, two desktops, six entertainment devices, and seven wireless appliances such as thermostats, car chargers, remotely controllable ovens and lighting systems. A modern home easily houses more than 20 wireless devices. Setting up a test environment in a lab that tests the performance of wireless access points or mobile devices in a modern home is challenging, at best.

The combination of multiple devices and OTA coupling inside test chambers has frustrated testbed calibration efforts. Rotation of devices within test chambers during a test further complicates calibration. Manual calibration of a single pairwise connection for a single orientation of a device under test typically requires special measurement equipment and may take 10 minutes. The number of pairwise connections grows quadratically with the number of devices. As a result, manual calibration for a particular test most often is not performed when there are pairwise connections among ten or more devices (even five or more devices.)

The technology disclosed conducts self-calibration of path loss automatically, without special measurement equipment or ten minutes of user operations per connection. Pairwise connections in a testbed naturally are made over connective cables. We disclose equipping pairwise connective cables, which may require repeated calibration, with measuring devices and controllable attenuators. A controller causes reference signals to be transmitted from each end of a pairwise connection and collects measured path losses, which account for actual OTA path loss. Uncertainty about path loss over a pairwise connection during testing can be eliminated by the controller setting the attenuator to produce a known, controlled path loss. Then, testing proceeds under known conditions. Uncertainty due to OTA path loss within chambers is virtually eliminated by testbed self-measurement and controlled attenuation, which have proven to be impractical to perform manually.

The technology disclosed sets the testbed to a reliable known condition, over which test scenarios can be super-imposed. Super-imposition of model environments onto the testbed is the subject of the contemporaneously filed application ABCD.

Some examples in the disclosure involve the 802.11 standard. The phrase “wireless devices” used here includes tangible stations (“STA”), tangible access points (“APs”), emulated STAs, and emulated APs.

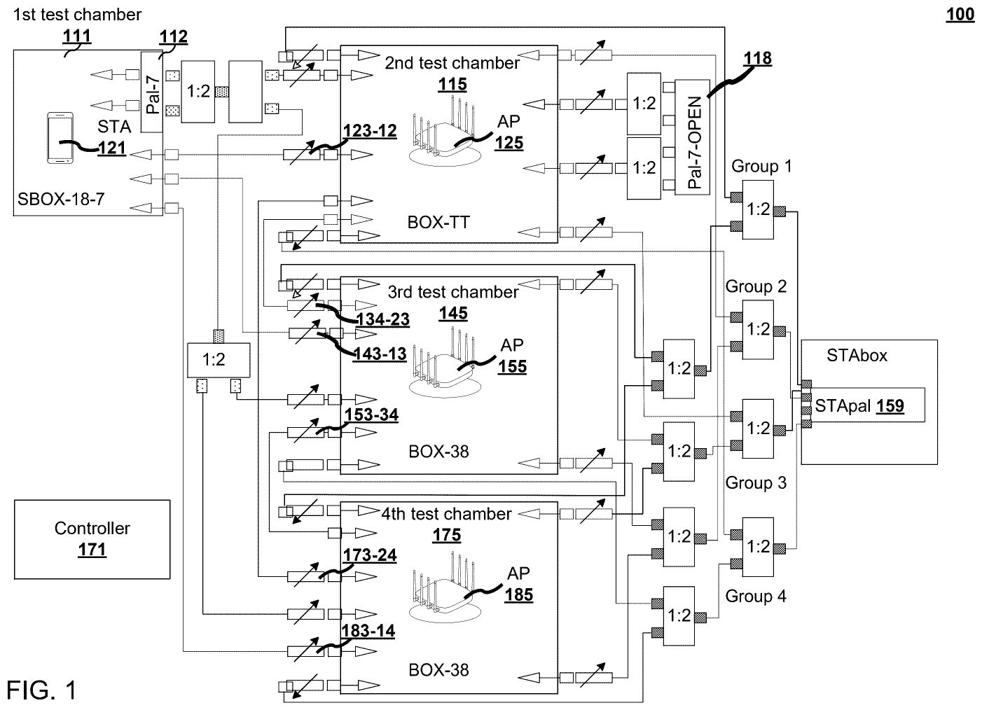

FIG. 1 illustrates a block diagram of a wireless device testbed that emulates a wireless network. In the illustrated test bed, there are four electromagnetically isolated test chambers, a controller, emulators for multiple devices wireless devices, and connective cables between the test chambers and emulators. While the connections among chambers are illustrated, connections from the controller to other devices are omitted for the sake of clarity. Each of the connective cables, for instance between test chambers and emulators/other test chambers, include an attenuator with a diagonal arrow and measurement device. These components of the connective cable are connected to the controller for signal measurement and attenuation control. Each of the test chambers shown include antennas represented by triangles inside test chamber boxes. Three of the test chamber boxes hold access points and the other holds one or more mobile devices. Of course, the number of test chambers and emulators as well as the configuration of connections can be varied to accommodate the desired test.

Testbed 100 is a system in a test environment that includes a plurality of electromagnetically isolated test chambers. The illustrated test chambers include first test chamber 111, second test chamber 115, third test chamber 145 and fourth test chamber 175. The testbed also includes a plurality of attenuators and measurement devices (sharing the same symbol and reference numbers in this figure for simplicity) 123-12, 143-13, 183-14, 134-23, 173-24 and 153-34. The measurement devices eavesdrop on signals passing through the connective cable and measure received signal strength. Measurements are accessible to the controller, either by broadcast from the measurement device or in response to queries. The testbed includes a mobile device under test referred to as a station (“STA”) 121 in the first test chamber 111. The second through fourth test chambers hold access points (“AP”) 125, 155, 185. The testbed includes a variety of emulators. Suitable emulators in the OCTOBOX® PAL® family includes PAL-7 112, PAL-7-Open 118 and STApal-7 159. Earlier and later versions of these emulators (e.g., -6 and -8) can be used. The emulators can perform a variety of emulation and measurement tasks. The PAL-7, for instance, functions as Wi-Fi traffic endpoints or OCTOBOX® Synchrosniffer® probes for performance testing and expert analysis of Wi-Fi devices. It can be used as a traffic generator end point (WAN or LAN) to enable high throughput measurement scenarios (3 Gbps+). Separated traffic and management ports can enable simultaneous measurement and data visualization. PAL-7 also implements up to 256 vSTAs. The PAL-7 can operate as a standalone unit or be built into an OCTOBOX® chamber, making that chamber a Smartbox®. The datasheet OCTOBOX® PAL-7 (May 3, 2024) provides additional details and is incorporated by reference. See, also, U.S. Pat. No. 10,897,319, “Integrated wireless communication test environment”, which is incorporated by reference. The STApal-7, for instance, functions as Wi-Fi traffic endpoints or OCTOBOX® Synchrosniffer® probes. A STApal-7 can function as an off-the-shelf device or as a precision test instrument. It can monitor and plot RSSI, data rate, number of spatial streams, channel width and other physical layer information. With a PalBOX®, you can generate OFDMA and MU-MIMO traffic simultaneously, plus traffic load from up to 96 virtual stations. More details are provided in the datasheet OCTOBOX® STApal-7 (Jul. 30, 2024) which is incorporated by reference. So-called “Open” versions of the PAL® and STApal® devices can be outfitted with antennas and function as a Synchrosniffer® or as traffic endpoints, as described in the datasheets.

Testbed 100 also includes controller 171. The controller sets up the testbed and conducts tests. It is connected to measurement devices and attenuators. It is connected to emulators and mobile devices within chambers, so as to configure them and cause them generate test traffic. Mobile devices in the test chambers can run apps that allow the controller to interact with applications on the mobile devices or to generate traffic that emulates apps on the mobile devices. The apps on the mobile devices communicate through APs and potentially through a mesh of APs to interact with servers or emulated servers.

Test chambers 111, 115, 145 and 175 are connected to one another. Pairs of test chambers are connected by connective cables configured with an attenuator and a measurement device. For example, first test chamber 111 and second test chamber 115 are connected by a connective cable configured with attenuator and measurement device 123-12.

First test chamber 111 is an electromagnetically isolated chamber that contains STA 121 and is physically coupled by a connective cable with an emulator 112. An OCTOBOX® chamber that is suitable for first test chamber 111 is an 18-inch-wide chamber. A suitable emulator is a PAL-7. Second test chamber 115 is configured with a turntable that rotates the contained wireless device. Here, second test chamber 115 contains AP 125 and a packet sniffer and emulator 118. A suitable packet sniffer and emulator is a PAL-7 OPEN. Third test chamber 145 contains AP 155. Fourth test chamber 175 contains AP 185. At least one test chamber relies on OTA coupling between antennas in the chamber and antennas built into a wireless device positioned in the chamber. Other test chambers can also involve OTA coupling or galvanic (soldered) connection to a wireless device antenna.

STA 121, and APs 125, 155, and 185 are tangible wireless devices that comply with one of the WiFi 802.11 family of standards or a subsequently developed standard. The wireless devices typically also have cellular and/or Bluetooth® radios. As stated earlier, at least one wireless device uses OTA coupling with the antennas of its respective test chamber.

Emulators 112, 118 and 159 can be used to emulate wireless devices that operate in accordance with 802.11 standards. Examples of wireless devices include, and are not limited to, APs, cell phones, laptops, tablets and Internet of Things appliances. The emulators also can emulate servers or services on the Internet. This example uses PAL® emulators from OCTOSCOPE®. In this example implementation, STApals 159 are used to emulate STAs.

Attenuators corresponding to reference numbers 123-12, 143-13, 183-14, 134-23, 173-24 and 153-34 reduce the power of signals sent along its respective connective cable without distorting the waveform. During calibration, the attenuators are set to an initial attenuation value, such as causing no additional attenuation or causing a predetermined attenuation. Signals transmitted between first test chamber 111 and the second test chamber 115 are attenuated by attenuator 123-12 in accordance with its set value. Respective measurement devices cavesdrop and measure received versions of reference signals transmitted between the pairs of test chambers. The eavesdropping and measurement are applied to the received versions of reference signals transmitted in both directions. For example, a signal is transmitted from first test chamber 111 to second test chamber 115 and another signal is sent from second test chamber 115 to first test chamber 111. Both signals are packet sniffed and measured by measurement device 123-12. In this example, respective measurement devices measure a Received Signal Strength Indicator (“RSSI”). Other suitable reference signal measurements to determine path loss (e.g. Reference Signal Received Power (“RSRP”) are understood by those skilled in the art. Of course, more or fewer test chambers and emulators can communicate over connective cables with controllable attenuators. The number of components and their functions depend on the test being conducted.

Controller 171 is operatively connected to STA 121, APs 125, 155 and 185, emulators 112, 118, 159, and attenuators and measurement devices 123-12, 143-13, 183-14, 134-23, 153-24 and 153-34. These operative connections are not shown in FIG. 1 to avoid undue complexity to the figure.

Controller 171 causes the transmission of reference signals between wireless devices in pairs of test chambers. For devices that can generate signals, an app running on the device can be invoked by the controller and instructed to transmit desired reference signals. Controller 171 can also cause reference signals to be transmitted between test chambers and other connected signal sources or between any two connected signal sources. Reference signals are carried over connective cables and over APs, a mesh, and other devices that act as repeaters. At the measurement devices, the signals transmitted as reference signals are referred to as received signals, because they are attenuated from their reference transmission values. Controller 171 receives measurements from respective measurement devices positioned on the connective cables. The process of generating and measuring reference signals can be repeated, including repeated using different signal frequencies. Based on the received measurements, controller 171 determines and sends configuration signals with attenuation values to the respective attenuators that cause the attenuators to produce a controlled path loss between the pair of signal sources. Model characteristics can be superimposed on a base attenuated path loss or the path loss attenuation can initially be set to match a model level.

In an extended implementation that emulates a model environment, controller 171 has access to information regarding model path losses between pairs of wireless devices in different physical locations in a model environment. Based on the model environment information, controller 171 accounts for the measured path loss and calibrates testbed 100 to emulate the model environment by sending configuration signals to the attenuators. After the attenuators are configured, the path loss between pairs of wireless devices reproduces the path losses between the pairs in the modeled environment.

Path loss in a home can be affected by distance between two devices, walls, furniture, and environmental effects including absorption or reflection of the signal. The configuration signals encompass configuring the attenuators to simulate distance and effects.

The above test system implementation is an example of the testing system. Other variations, especially with different counts of components, will be understood by those skilled in the art based on this disclosure.

Testbed 100 could include more connections between components than are shown. This implementation does not amount to a fully connected graph of components, because, for instance, the STAbox hosting STApals 159 is not directly connected to first test chamber 111. Variations model the effect of background noise of a STA emulated by STApals 159. The testbed can include additional connective cables with more or fewer test chambers. Although the example includes a single STA and three APs in chambers, in other examples, the number of STAs and the number of APs can be increased or decreased. Although the example shows STAs emulated by STApals 159, both STAs and APs can also be emulated by other emulator components.

The example uses wireless devices that are 802.11 compliant. In variations, testbed 100 can self-calibrate and test other wireless technologies. For example, the APs could be replaced with eNodeBs, and the self-calibration can model cellular network environments using cellular protocols, or Bluetooth® communications between devices using Bluetooth® protocols. Pals can be used to emulate base stations. This disclosure encompasses self-calibration to test other wireless technologies beyond wireless, cellular, or Bluetooth®.

The illustrated example uses an OCTOBOX® testbed with PAL® emulators. Variations may use other electromagnetically-isolated test chambers and other emulators of STAs or APs.

The above variations are not exhaustive, and further variations are understood by those skilled in the art.

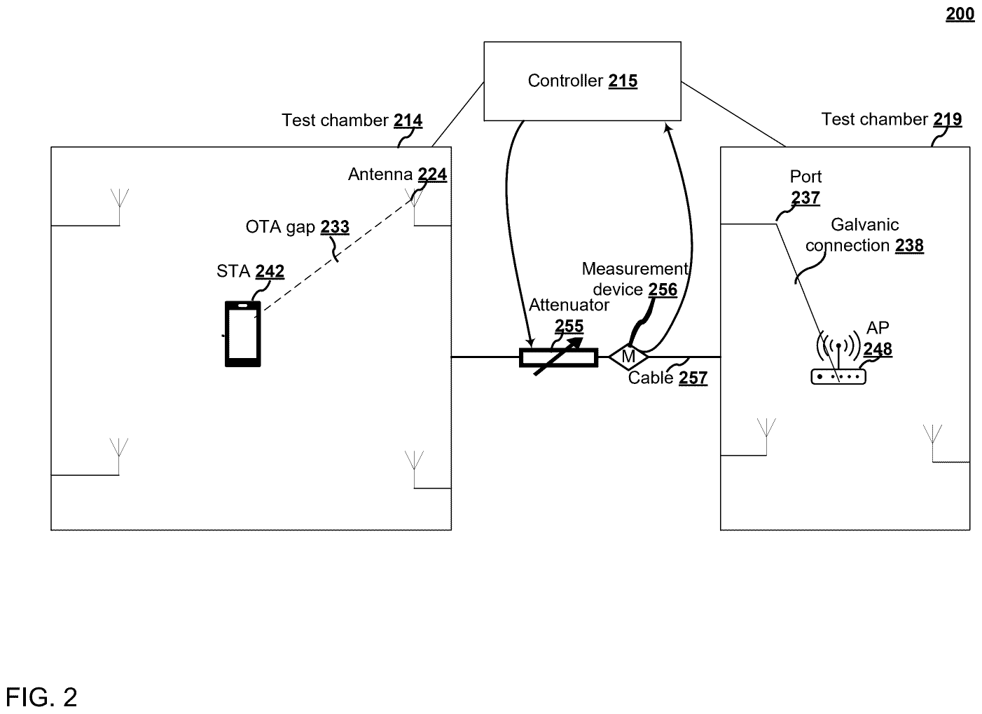

FIG. 2 illustrates a connective cable between a pair of test chambers including an Over the Air (“OTA”) gap, being configured by a controller.

Diagram 200 includes test chambers 214, 219, antenna 224, port 237 station (“STA”) 242, access point (“AP”) 248, OTA gap 233 (represented by a dashed line), galvanic connection 238, connective cable 257, attenuator 255 measurement device 256, and controller 215.

Test chamber 214 includes antenna 224 and STA 242 coupled over OTA gap 233.

Test chamber 219 includes port 237 and AP 248 coupled to an antenna of AP 248 by a cable and galvanic (soldered) connection.

Connective cable 257 between the test chambers includes attenuator 255 and measurement device 256. Connective cable 257 conveys attenuated RF signals between test chambers 214 and 219.

Controller 215 adjusts attenuator 255 during self-calibration of the testbed. During the configuration, STA 242 and AP 248 transmit reference signals to each other. These reference signals are simple signals transmitted at a predetermined power level. For wireless devices that follow 802.11 standards, the reference signals can be Modulation Coding Scheme 0 (“MCS0”) signals such as probe requests and responses, but reference signals can also be other signals, including custom signals. The reference signals are transmitted from both wireless devices in the pair to the respective wireless device over OTA gap 233.

Measurement device 256 eavesdrops the reference signals in both directions, measures the path losses, and sends the measured path losses to controller 215.

Controller 215 adjusts attenuator 255 with an attenuator value such that a signal sent between STA 242 and AP 248 reproduces the path loss between STA 242 and AP 248 in a model environment. Controller 215 obtains the attenuator value by comparing the measurements collective over the respective connective cable with OTA coupling against one or more previously established values for path loss over the respective cable without any OTA coupling at either the first or second paired source.

In variations, transmitting, eavesdropping, measuring and configuring may repeated several times at the same frequency or a variety of frequencies. Additionally or alternatively, if a test chamber with an OTA gap is configured with a turntable, at least the transmitting, eavesdropping and measuring can be repeated at a variety of angles of rotation of the wireless device in the chamber. Configuring the attenuator can use an attenuator value based on an average of multiple measurements over the different angles. Additionally or alternatively, transmitting and eavesdropping can also be repeated by the test chambers with signals at different power levels.

In some variations, technologies related to other protocols may be tested. In some variations, both test chambers have OTA gaps, or both can have galvanic connections. In some variations, the wireless devices are of the same type (e.g. AP-AP instead of STA-AP).

In some variations, the connective cables can also be fitted with other signal-altering devices that model other effects on signals.

The above variations are not exhaustive, and further variations will be understood by those skilled in the art.

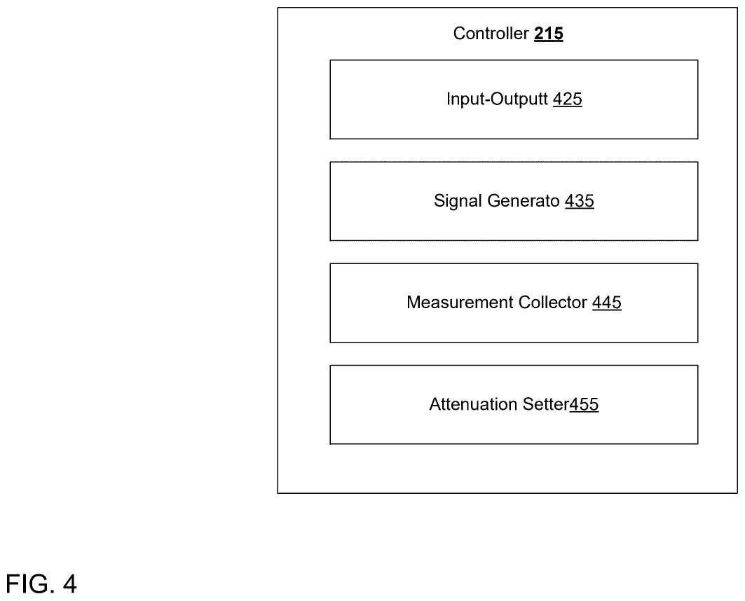

FIG. 4 is a block diagram illustrating functional blocks of controller 215 that are involved in self-calibration. Block 425 is an input-output block that handles communications with components of the test bed and with a user. Communications can be over RF, wired Ethernet or wireless connections. Block 435 is a configuration signal generator. The controller communicates with a user who controls the system and with signal sources that can generate reference and test signals. The signal sources can run an app that either generates signals or that interfaces with an app on the signal source, such as a mobile phone or tablet, to generate a variety of types of signals. A reference signal for self-calibration can be generated by a test app or a native component of the signal source. During quality of experience (“QoE”) testing, an actual application such as a YouTube® app running on a mobile phone could request, receive and playback a video. A game running on a tablet could send commands and user communications to other users during game play. The game could receive screen updates, game audio, and communications with the other users engaged during the game. Block 445 is a measurement collector. This block interacts with measurement devices on the connective cables to collect reports of measurements. For instance, the block can start and later stop measurement broadcasting or can request a single or fixed number of measurement values, such as a received signal strength values, from a measurement device. Block 455 is an attenuation setter that determines attenuation values for attenuators and sets respective attenuators to the values determined. The values can be reference, base values, or model values. Base values can prepare the system to be configured to model path loss values. Base values can be established repeatedly or once for a series of tests. If a model is selected before self-calibration, the attenuation values could be set directly to model values, without establishing base path loss values. Not shown is a QoE evaluation module, as the QoE testing is the subject of a related application listed above. Testing in general is covered by other applications and technical literature published by applicant Spirent Communications. The next figure illustrates a message diagram for self-calibration.

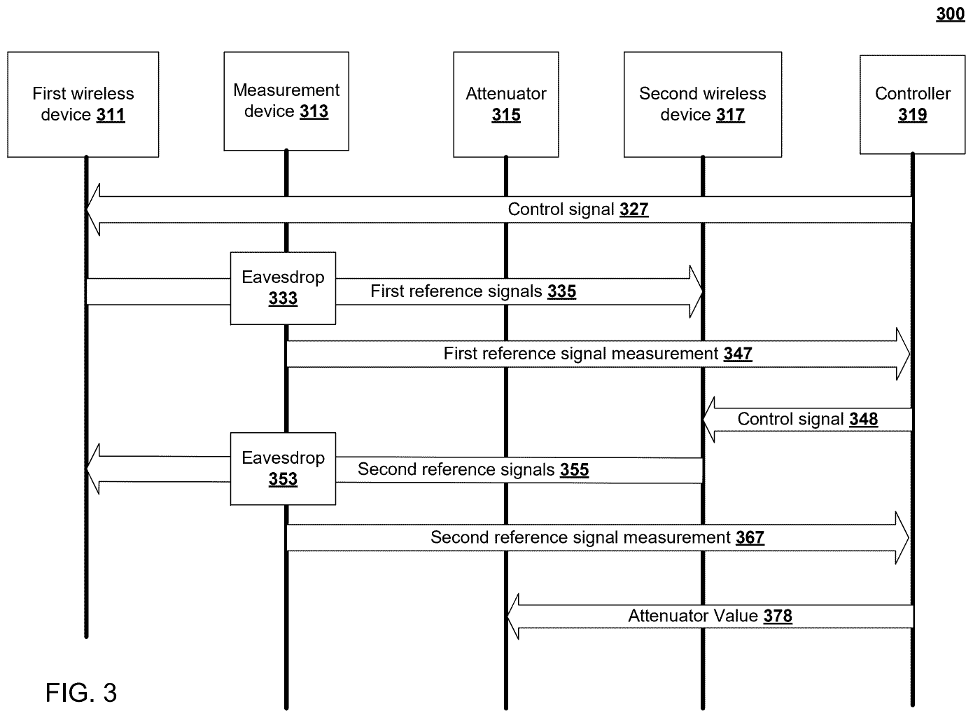

FIG. 3 is a message diagram illustrating messages exchanged during self-calibration of a pairwise connection over a connective cable between a pair of signal sources in the testbed. Message diagram 300 has entities, messages and events. Entities include first and second wireless devices 311 and 317, measurement device 313, attenuator 315 and controller 319. Not shown are a user console from which a user commands the controller to initiate self-calibration and other test and from which the user learns of completion and resulting signal. Also not shown are preparatory messages that launch self-calibration.

The first messages shown include a control signals 327, 348 from controller 319 to first and second wireless devices 311, 317 to cause the devices to initiate transmission of reference signals. Not shown is a message from the controller to the wireless devices to set their respective signal transmission strength levels, which are often controllable. For test self-configuration purposes, it can be desirable to set the reference signal strength instead of relying on devices under test to decide what signal strength to use. The first reference signal 335 is transmitted from the first wireless device 311 through a measurement device 313 to second wireless device 317, over a connective cable. The second reference signal 355 is transmitted from the second wireless device 317 through the measurement device 313 to the first wireless device 311. The measurement device 313 eavesdrops on and measures (333, 353) both the first and second reference signals 335, 355. After making measurements, the measurement device 313 sends measurement values to the controller 319 in first and second measurement signals 347, 367. Not shown is any query or command from the controller 319 to the measurement device 313 to cause it to measure and report signal values. The controller 319, after receiving measurements and determining an attenuation value, sends a command 378 to the attenuator 315 paired with the measurement device 313 to set the level of attenuation to be applied.

Wireless devices 311 and 317 are contained in respective test chambers. For this example, wireless device 311 is a station and wireless device 317 is an access point that both comply with 802.11 standards. One or both wireless devices are coupled OTA with an antenna in its test chamber. The pair of test chambers are connected with a connective cable configured with measurement device 313 and attenuator 315. Of course, one of the wireless devices can be an emulator, as opposed to a device in a test chamber. Before the configuration process begins, attenuator 315 is set to produce a known, controlled path loss.

Controller 319 is operatively connected to the other illustrated entities in this figure.

Reference signals can be simple low-powered signals. For this example of 802.11 compliant devices, the reference signals can be Modulation MCS0 signals. An example of MCS0 signals is probe requests/responses. A single command to the first wireless device, in some instances, will cause the second device to respond with a measurable signal, obviating any need for a second request from the controller 348. One or more control signals 327, 348 can specify desired features of the reference signals, such as power level and destination.

In some variations of the above example, transmission of second reference signal 355 is expressly invoked by controller 319 through another control signal to wireless device 317, instead of being transmitted responsive to receipt of first reference signal 335.

### Computer System

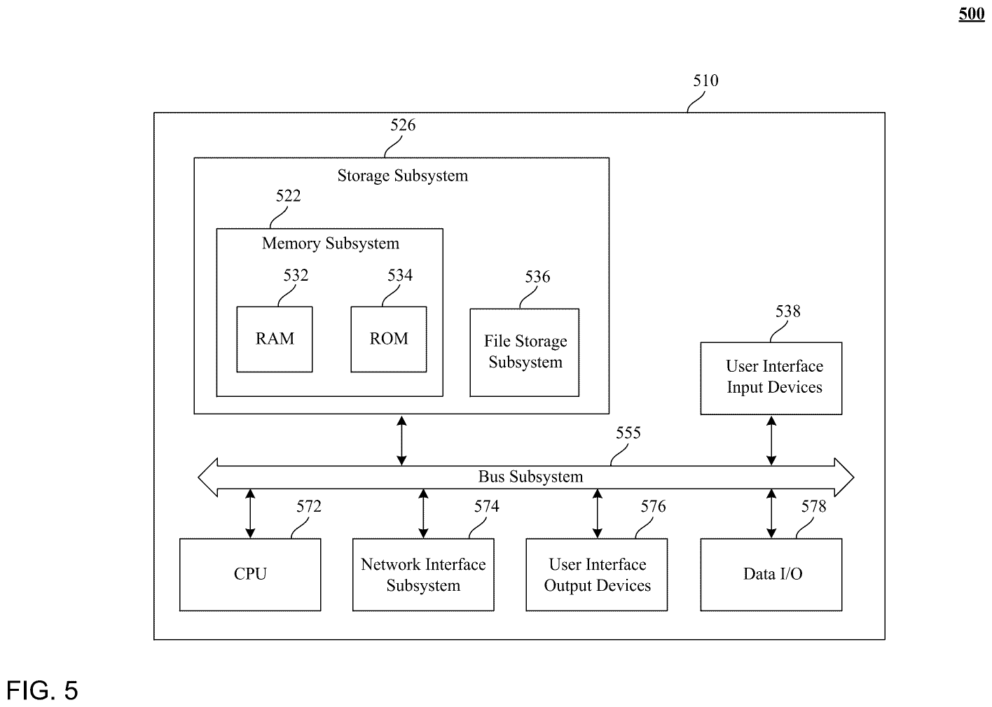

FIG. 5 is a simplified block diagram 500 of a computer system that can be used to implement controllers or emulators. Computer system 510 includes at least one central processing unit (CPU) 572 that communicates with a number of peripheral devices via bus subsystem 555. These peripheral devices can include a storage subsystem 526 including, for example, memory devices 522 and a file storage subsystem 536, user interface input devices 538, user interface output devices 576, a network interface subsystem 574, and data I/O call 578. The input and output devices allow user interaction with computer system 510. Network interface subsystem 574 provides an interface to outside networks, including an interface to corresponding interface devices in a communication network with other computer systems.

In one implementation, controller 171 of FIG. 1 can be communicably linked to the storage subsystem 526 and the user interface input devices 538. User interface input devices 538 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 510.

User interface output devices 576 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 510 to the user or to another machine or computer system.

Storage subsystem 526 stores programming and data constructs that provide the functionality of some or all of the modules and methods described herein.

Memory subsystem 522 used in the storage subsystem 526 can include a number of memories including a main random-access memory (RAM) 532 for storage of instructions and data during program execution and a read only memory (ROM) 534 in which fixed instructions are stored. A file storage subsystem 536 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 536 in the storage subsystem 526, or in other machines accessible by the processor.

Bus subsystem 555 provides a mechanism for letting the various components and subsystems of computer system 510 communicate with each other as intended. Although bus subsystem 555 is shown schematically as a single bus, alternative implementations of the bus subsystem can use multiple busses.

Computer system 510 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 510 depicted in FIG. 5 is intended only as a specific example for purposes of illustrating the preferred embodiments of the present invention. Many other configurations of computer system 510 are possible having more or less components than the computer system depicted in FIG. 5.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

### Particular Implementations

Some particular implementations and features are described in the following discussion.

In one implementation, a method of a self-calibrating testbed from the perspective of a controller is described. The testbed includes a controller and signal sources. Pairs of the signal sources coupled by respective connective cables. Each of the respective connective cable is fitted with a respective attenuator and respective measurement device. The signal sources include test chambers equipped with antennas and holding a respective wireless device that is wirelessly coupled to the antennas and station emulators that exchange signals with the respective wireless devices in the test chambers.

The method involves the controller calibrating the testbed, for the respective connective cables connecting the pairs of signal sources, by repeatedly performing the following:

The method includes causing transmission of first reference signals through the respective connective cable from a first paired signal source to a second paired signal source. The method also includes causing transmission of second reference signals through the respective connective cable from the second paired signal source to the first paired signal source. The method also includes collecting measurements of a first received signal from the first paired signal source by the respective active measurement device. The method also includes collecting measurements of a second received signal from the second paired signal source by the respective active measurement device. The method also includes configuring the respective attenuator to establish a known pairwise path loss over the respective connective cable using the measurements of the first and second received signals.

This method in other implementations of the technology disclosed can include one or more of the following features and/or features described in connection with additional methods disclosed. In the interest of conciseness, the combinations of features disclosed in this application are not individually enumerated and are not repeated with each base that of features. The reader will understand how features identified in this section can readily be combined with sets of these features identified as implementations.

In some implementations, the method includes the controller comparing the measurements collected over the respective connective cable, for a pairwise connection including at least one OTA coupling, against one or more previously established values for path loss over the respective cable without any OTA coupling at either the first or second paired source, and reporting at least one measured OTA path loss for the first and/or second paired sources based on the comparing.

In some implementations, the controller can repeat the calibrating using first and second reference signals at a changed frequency.

In some implementations, the signal sources include at least one test chamber holding a wireless device with a galvanic connection to at least one wireless device antenna.

In some implementations, the first and second received signals are measured by a Received Signal Strength Indicator (“RSSI”) or a Reference Signal Received Power (“RSRP”).

In some implementations, the first and second reference signals includes MCS0 signals.

In some implementations, the path loss uncertainty between at least one pair of signal sources is reduced from over 20 dB to under 5 dB.

In some implementations, at least one pair of the signal sources includes a pair of wireless devices coupled over the air to antennas in a pair of test chambers. In these implementations, the method further includes reducing uncertainty between of path loss between the at least one pair of signal sources from over 20 dB to under 5 dB.

In another implementation, a disclosed system includes one or more processors coupled to memory, the memory loaded with computer instructions, when executed on the processors, implement any of the disclosed methods.

In yet another implementation a disclosed tangible non-transitory computer readable storage medium is impressed with computer program instructions that, when executed on a processor, implement any of the disclosed methods.

The technology disclosed can be practiced as a system, method, or article of manufacture. One or more features of an implementation can be combined with the base implementation. Implementations that are not mutually exclusive are taught to be combinable. One or more features of an implementation can be combined with other implementations.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A method of self-calibrating a testbed, that establishes a known, base path loss between devices by adjusting attenuators in the testbed based on measured Over the Air (“OTA”) path loss,
wherein the testbed includes:
a controller,
signal sources including
test chambers equipped with antennas and holding respective wireless devices that are wirelessly coupled to the antennas and
station emulators that exchange signals with the respective wireless devices in the test chambers; and
pairs of the signal sources coupled by respective connective cables fitted with a respective attenuator and a respective measurement device;
the method includes the controller calibrating the testbed, for the respective connective cables that connect the pairs of signal sources, including repeatedly:
causing transmission of first reference signals through the respective connective cable from a first paired signal source to a second paired signal source;
causing transmission of second reference signals through the respective connective cable from the second paired signal source to the first paired signal source;
collecting measurements of a first received signal from the first paired signal source by the respective measurement device;
collecting measurements of a second received signal from the second paired signal source by the respective measurement device; and
configuring the respective attenuator to establish a known pairwise path loss over the respective connective cable using the measurements of the first and second received signals.

2. The method of claim 1, further including the controller:
comparing the measurements collected over the respective connective cable, for a pairwise connection including at least one OTA coupling, against one or more previously established values for path loss over the respective cable without any OTA coupling at either the first or second paired source; and
reporting at least one measured OTA path loss for the first and/or second paired sources based on the comparing.

3. The method of claim 1, wherein the signal sources further comprise:
at least one test chamber holding a wireless device with a galvanic connection to at least one wireless device antenna.

4. The method of claim 1, wherein the first and second received signals are measured by a Received Signal Strength Indicator (“RSSI”) or a Reference Signal Received Power (“RSRP”).

5. The method of claim 1, wherein the first and second reference signals include MCS0 signals.

6. The method of claim 1, further including the controller repeating the calibrating using first and second reference signals at a changed frequency.

7. The method of claim 1, wherein path loss uncertainty between at least one pair of signal sources is reduced from over 20 dB to under 5 dB.

8. The method of claim 1, wherein at least one pair of the signal sources includes a pair of wireless devices coupled over the air to antennas in a pair of test chambers;
the performance further including reducing uncertainty between of path loss between the at least one pair of signal sources from over 20 dB to under 5 dB.

9. A non-transitory computer readable storage medium impressed with computer program instructions of self-calibrating a testbed that establishes a known, base path loss between wireless devices by adjusting attenuators in a testbed based on measured Over the Air (“OTA”) path loss,
wherein the testbed includes:
a controller,
signal sources including:
test chambers equipped with antennas and holding a respective wireless device that are wirelessly coupled to the antennas, and
station emulators that exchange signals with the respective wireless devices in the test chambers; and
pairs of the signal sources coupled by respective connective cables fitted with a respective attenuator and respective measurement device;
the computer program instructions of the controller calibrating the testbed that, when executed, cause the controller, for the respective connective cables that connect the pairs of signal sources, to repeatedly perform:
causing transmission of first reference signals through the respective connective cable from a first paired signal source to a second paired signal source;
causing transmission of second reference signals through the respective connective cable from the second paired signal source to the first paired signal source;
collecting measurements of a first received signal from the first paired signal source by the respective measurement device;
collecting measurements of a second received signal from the second paired signal source by the respective measurement device; and
configuring the respective attenuator to establish a known pairwise path loss over the respective connective cable using the measurements of the first and second received signals.

10. The non-transitory computer readable storage medium of claim 9, further including the controller performing:
comparing the measurements collected over the respective connective cable, for a pairwise connection including at least one OTA coupling, against one or more previously established values for path loss over the respective cable without any OTA coupling at either the first or second paired source; and
reporting at least one measured OTA path loss for the first and/or second paired sources based on the comparing.

11. The non-transitory computer readable storage medium of claim 9, wherein the signal sources further comprise:
at least one test chamber holding a wireless device with a galvanic connection to at least one wireless device antenna.

12. The non-transitory computer readable storage medium of claim 9, wherein the first and second reference signals are measured by a Received Signal Strength Indicator (“RSSI”) or a Reference Signal Received Power (“RSRP”).

13. The non-transitory computer readable storage medium of claim 9, wherein the first and second reference signals include MCS0 signals.

14. The non-transitory computer readable storage medium of claim 9, further including the controller repeating the calibrating using first and second reference signals at a changed frequency.

15. The non-transitory computer readable storage medium of claim 9, wherein path loss uncertainty between at least one pair of signal sources is reduced from over 20 dB to under 5 dB.

16. The non-transitory computer readable storage medium of claim 9, wherein at least one pair of the signal sources includes a pair of wireless devices coupled over the air to antennas in a pair of test chambers;
the performance further including reducing uncertainty between of path loss between the at least one pair of signal sources from over 20 dB to under 5 dB.

17. A self-calibrating testbed that establishes a known, base path loss between devices by adjusting attenuators in a testbed based on measured OTA path loss, the testbed comprising:
a controller,
signal sources including:
test chambers equipped with antennas and holding a respective wireless device that are wirelessly coupled to the antennas, and
station emulators that exchange signals with the respective wireless devices in the test chambers; and
pairs of the signal sources coupled by respective connective cables fitted with a respective attenuator and respective measurement device;
and computer program instructions loaded into a memory of the controller, that, when executed, cause the controller, for the respective connective cables that connect the pairs of signal sources, to perform repeatedly:
causing transmission of first reference signals through the respective connective cable from a first paired signal source to a second paired signal source;
causing transmission of second reference signals through the respective connective cable from the second paired signal source to the first paired signal source;
collecting a measurement of a first received signal from the first paired signal source by the respective measurement device;
collecting a measurement of a second received signal from the second paired signal source by the respective measurement device; and
sending a configuration signal to the respective attenuator to establish a known pairwise path loss over the respective connective cable using the measurements of the first and second received signals.

18. The self-calibrating testbed of claim 17, further including the controller performing:
comparing the measurements collected over the respective connective cable, for a pairwise connection including at least one OTA coupling, against one or more previously established values for path loss over the respective cable without any OTA coupling at either the first or second paired source; and
reporting at least one measured OTA path loss for the first and/or second paired sources based on the comparing.

19. The self-calibrating testbed of claim 17, wherein the signal sources further comprise:
at least one test chamber holding a wireless device with a galvanic connection to at least one wireless device antenna.

20. The self-calibrating testbed of claim 17, wherein the first and second reference signals are measured by a Received Signal Strength Indicator (“RSSI”) or by a Reference Signal Received Power (“RSRP”).

21. The self-calibrating testbed of claim 17, wherein the first and second reference signals include MCS0 signals.

22. The self-calibrating testbed of claim 17, further including the controller repeating the calibrating using first and second reference signals at a changed frequency.

23. The self-calibrating testbed of claim 17, wherein path loss uncertainty between at least one pair of signal sources is reduced from over 20 dB to under 5 dB.

24. The self-calibrating testbed of claim 17, wherein at least one pair of the signal sources includes a pair of wireless devices coupled over the air to antennas in a pair of test chambers;
the performance further including reducing uncertainty between of path loss between the at least one pair of signal sources from over 20 dB to under 5 dB.
